(19) United States
(12) Patent Application Publication
(10) Pub. No.: US 2023/0252245 A1
(43) Pub. Date: Aug. 10, 2023

(54) Systems and Methods for Contextual Post-Editing of Sentence-Level Translations

(71) Applicant: Google LLC, Mountain View, CA (US)

(72) Inventor: Melvin Johnson, Sunnyvale, CA (US)

(21) Appl. No.: 18/015,551

(22) PCT Filed: Aug. 7, 2020
(86) PCT No.: PCT/US2020/045358

§ 371 Date: Jan. 11, 2023

(51) Int. Cl. G06F 40/51; G06F 40/47

(52) U.S. Cl. CPC G06F 40/51; G06F 40/47

(57) ABSTRACT

Generally, the present disclosure is directed to systems and methods that leverage machine learning to perform post-editing of sentence-level translations that takes into account contextual information from the language source. As an example, the proposed post-editing system can run as a second pass to a sentence-level translation system and the goal of the post-editing system may be to refine translations which are affected by the larger context.

### FIELD

The present disclosure relates generally to machine translation. More particularly, the present disclosure relates to the use of machine learning models for contextual post-editing of sentence-level translations.

### BACKGROUND

Certain existing translation systems operate on a sentence-by-sentence basis. For example, for a paragraph containing three sentences, such sentence-by-sentence systems separately translate each of the three sentences, without regard to the content of the other sentences.

However, systems that operate in such fashion are not capable of handling context which may be available from other sentences (e.g., other sentences included in the same paragraph, document, or other language source). Failure to account for context when performing translation can result in a number of errors.

As one example, certain languages may use genderless pronouns (e.g., possessives) rather than gendered pronouns. For example, the Spanish sentence “Su camisa está verde” could be equivalently translated into English as “His shirt is green” or “Her shirt is green”.

As another example, sentence-by-sentence machine translation systems may exhibit errors when translating homonyms. For example, the word “bank” in the English sentence “The rain fell on the bank” could be equivalently translated into Spanish as “banco” (an institution that holds and lends money) or “orilla” (a riverbank or shore).

As another example, sentence-by-sentence machine translation systems may also exhibit errors when they encounter proper nouns or entities (e.g., Black Friday), particularly when references to the entity are inconsistent in the language source. This may be referred to as “lexical cohesion.”

As further examples, certain languages (e.g., Japanese) may leave out the subject or object of a verb when it can be inferred from the context, and some languages (e.g., Mandarin) may not explicitly resolve tense or number at every opportunity. More generally, existing translation systems may exhibit errors whenever translating from a less specific phrasing in one language to another language that requires a more specific phrasing.

One alternative to sentence-by-sentence translation is to attempt to translate an entire language source all at once. However, this approach has been found to be computationally infeasible and has failed to produce meaningful results: existing model architectures and approaches are simply not able to handle the very large amount of information required to simultaneously translate significant numbers of sentences in a single pass.

### SUMMARY

Aspects and advantages of embodiments of the present disclosure will be set forth in part in the following description, or can be learned from the description, or can be learned through practice of the embodiments.

One example aspect of the present disclosure is directed to a computing system for performing contextual post-editing of sentence-level translations. The computing system includes one or more processors and one or more non-transitory computer-readable media that collectively store: a machine-learned contextual post-editing model configured to refine a preliminary translation based on source context; and instructions that, when executed by the one or more processors, cause the computing system to perform operations. The operations include obtaining language data that describes a plurality of source sentences in a first language included in a language source. The operations include translating each of the plurality of source sentences to obtain a plurality of preliminary translated sentences in a second, different language. The operations include, for each of the preliminary translated sentences: processing, using the machine-learned contextual post-editing model, the preliminary translated sentence and the language data for at least one of the plurality of source sentences that does not correspond to the preliminary translated sentence to generate a refined translated sentence for the preliminary translated sentence; and providing the refined translated sentence as an output.

Another example aspect of the present disclosure is directed to a computer-implemented method for training a machine-learned contextual post-editing model to refine a preliminary translation based on source context. The method includes obtaining, by a computing system comprising one or more computing devices, a training dataset comprising one or more training example pairs, each training example pair comprising language data that describes a plurality of source sentences in a first language and at least one ground truth translated sentence that corresponds to a ground truth translation into a second, different language of at least one source sentence of the plurality of source sentences. The method includes, for the at least one source sentence of the plurality of source sentences: using, by the computing system, a sentence-level translation system to translate the source sentence to generate a preliminary translated sentence in the second, different language; processing, by the computing system and using the machine-learned contextual post-editing model, the preliminary translated sentence and at least one of the plurality of source sentences that does not correspond to the preliminary translated sentence to generate a refined translated sentence for the preliminary translated sentence; evaluating, by the computing system, a loss function that compares the refined translated sentence with the ground truth translated sentence that corresponds to the source sentence; and modifying, by the computing system, one or more values of one or more parameters of the machine-learned contextual post-editing model based at least in part on the loss function.

Another example aspect of the present disclosure is directed to one or more non-transitory computer-readable media that collectively store a machine-learned contextual post-editing model. Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIGS. 1A-D depict block diagrams of example systems to perform contextual post-editing of sentence-level translations according to example embodiments of the present disclosure.

FIGS. 2A-D depict block diagrams of example machine-learned contextual post-editing models according to example embodiments of the present disclosure.

FIG. 3 depicts a block diagram of an example training scheme to train a machine-learned contextual post-editing model according to example embodiments of the present disclosure.

FIG. 4A depicts a block diagram of an example computing system that performs machine translation according to example embodiments of the present disclosure.

FIG. 4B depicts a block diagram of an example computing device that performs machine translation according to example embodiments of the present disclosure.

FIG. 4C depicts a block diagram of an example computing device that performs machine translation according to example embodiments of the present disclosure.

Reference numerals that are repeated across plural figures are intended to identify the same features in various implementations.

### DETAILED DESCRIPTION

### Overview

Generally, the present disclosure is directed to systems and methods that leverage machine learning to perform a post-editing of sentence-level translations, where the post-editing takes into account contextual information from the language source. As an example, the proposed post-editing system can run as a second pass to a sentence-level translation system and the goal of the post-editing system may be to refine translations which are affected by the larger context.

More particularly, the proposed system can provide improved translation of a language source that includes a plurality of source sentences in a first language. For example, the language source can be an audio file (e.g. an audio file which is the output of at least one microphone arranged to receive a user's speech) that corresponds to speech of the plurality of source sentences, textual data that includes text of the plurality of source sentences, or imagery that visually depicts the plurality of source sentences. In some examples the language source can be a document (e.g., a web document such as a website, a word processing document, etc.). In another example, the language source can be an audio file associated with a video (e.g., a video posted to a social media or video sharing platform, a movie or show on a streaming platform, etc.). In some examples, the image data can include, e.g., spectrographic images of audio data (“spectrograms”).

The proposed systems and methods can translate each source sentence in the first language from the language source into a translated sentence in a second, different language. In particular, example implementations of the present disclosure execute a two-stage translation process in which a sentence-by-sentence translation system is used to generate a preliminary translated sentence for each source sentence. Then, according to an aspect of the present disclosure, the proposed systems and methods can use a machine-learned contextual post-editing model to refine the preliminary translation based on source context (e.g., one or more other source sentences that do not correspond to the preliminary translation being refined).

In particular, some implementations of the proposed contextual post-editing system can encode a source sentence with some or all of surrounding source context along with a preliminarily translated version of the source sentence and (optionally) some or all of the surrounding preliminarily translated target context. Various implementations of the proposed system can have varying amounts of context on the source (e.g., in the case that the language source is an ordered sequence of source sentences (a “source sequence”), the source context may comprise or consist of one or more other sentences in the source sequence; for example, the preliminary translation of each source sentence (except perhaps the first and/or last source sentences of the source sequence) can be refined using one or more immediately preceding and/or one or more immediately succeeding source sentences in the source sequence, i.e. past and/or future contextual source sentences) and/or varying amounts of context on the target (e.g., the preliminary translation of each source sentence (except perhaps the first and/or last source sentences of the source sequence) can be refined using the preliminary translations of one or more immediately preceding and/or one or more immediately succeeding source sentences in the source sequence, i.e. past and/or future preliminary translations). Alternatively or additionally, a given preliminary translation can optionally be refined using previously produced refined translations of other sentences in the source sequence.

The machine-learned contextual post-editing model can process the provided context and refine the preliminary translation that is currently being considered. For example, in some implementations, the source context can be encoded by a context encoder and the target context by a translation encoder of the machine-learned contextual post-editing model into respective embeddings. Alternatively, a single encoder can generate a single embedding based on a combined input. These embedding(s) can then be utilized by a decoder (e.g., a multi-source decoder) of the machine-learned contextual post-editing model to produce the refined translation. The decoder can generate edits to the preliminary translated sentence or can directly output the refined sentence. Similar to the language source, the outputted refined translated sentence can be formatted as audio data, textual data, and/or image data. The image data can include, e.g., spectrographic images of audio data (“spectrograms”). If the output refined translated sentence is audio data, it can be transmitted as control data to a loudspeaker, and transformed into sound. Alternatively, if the outputted refined translated sentence is textual data it can be input to a text-to-audio converter to generate audio data, and then transmitted to the loudspeaker. In this way, the present disclosure may provide an automatic interpretation system which transforms audio data representing speech in the first language received by a microphone and comprising the source sequence, into translated speech in the second language produced by the loudspeaker. The steps of the process may be performed concurrently, such that the loudspeaker outputs sound representative of earlier sentences of the source sequence while the microphone is receiving sound representative of later sentences of the source sequence.

In some implementations, the machine-learned contextual post-editing model can have a sequence-to-sequence architecture which uses encoder(s) configured to encode input sequence(s) and a decoder configured to generate an output sequence. As examples, the encoder(s) and decoder(s) can be transformer models, recurrent neural networks (e.g., long short-term memory networks), and/or other models configured to process or handle sequential data.

The systems and methods of the present disclosure provide a number of technical effects and benefits. As examples, technical effects and benefits may be understood by comparison of the proposed post-editing approach with systems that attempt to translate an entire language source all at once end-to-end. For example, the proposed post-editing model requires a significantly smaller amount of training data versus a model that attempts to perform a complete translation in a single pass. Being able to train the model with less training data can result in reduction of usage of computing resources such as reduced processor usage, reduced memory usage, and reduced network bandwidth usage.

As another example, the proposed post-editing model will be significantly smaller (e.g., in number of parameters) versus a model that attempts to perform a complete translation in a single pass. The smaller size will enable the post-editing model to be run faster (e.g., with less latency). Similarly, having a smaller model can result in reduction of usage of computing resources such as reduced processor usage, reduced memory usage, and reduced network bandwidth usage.

Furthermore, systems which have attempted to translate an entire language source all at once end-to-end have not demonstrated consistently high-quality empirical results. For example, when end-to-end models are used to translate a large language source, most of the context is not relevant and therefore the model generates poor results and wastes computational resources attempting to model the non-relevant context.

In contrast, the proposed approach is able to consistently provide refined translations regardless of the size of the language source. For example, a user-controllable window of context may be provided at each refinement pass, which can enable the model to process only the most relevant context. Thus, the proposed systems and methods represent an improvement to the translation ability of a computing system.

As another example technical effect and benefit, the proposed systems can be used to correct or refine many different types of contextual phenomena (e.g., gender phenomena, proper noun phenomena, dropped object or subject phenomena, tense or number resolution phenomena, etc.). Thus, the proposed systems are far more general and robust relative to existing specialized systems which attempt to identify and resolve a single, specific problem.

As another example technical effect and benefit, the proposed systems can provide improved performance relative to a system that seeks to post-edit based only on context on the target (e.g., past preliminary translations). For example, a system that seeks to post-edit a translated sentence based only on other previously translated sentences may be unable to correct certain errors introduced and/or cascaded by a sentence-level translation system. Stated differently, once a sentence-level translation system has introduced an error into a translated sentence, using that translated sentence as context for correcting other translated sentences is of limited benefit, as the error may not be recognizable as such or may be cascaded via false corrections for the sake of consistency. In contrast, providing source context to the model which enables the model to understand the untranslated source context and therefore correct and/or prevent cascading of errors introduced by the sentence-level translation system.

As another benefit, the proposed approach can be easily appended to any existing sentence-level translation system. In addition, the post-editing system can be selectively applied to outputs from the sentence-level translation system. For example, the post-edit step can be selectively activated when context is available.

With reference now to the Figures, example embodiments of the present disclosure will be discussed in further detail.

### Example Translation Systems

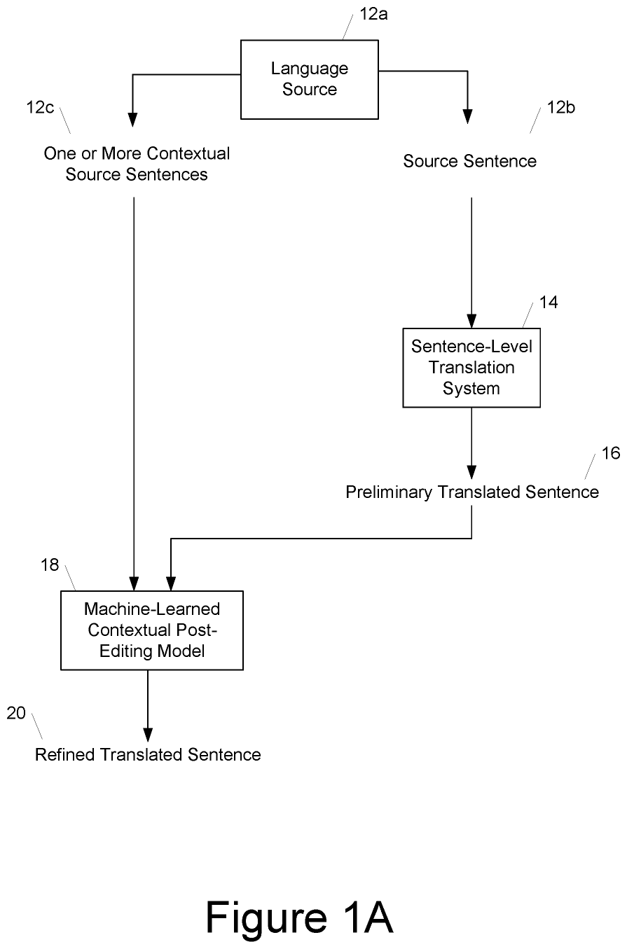

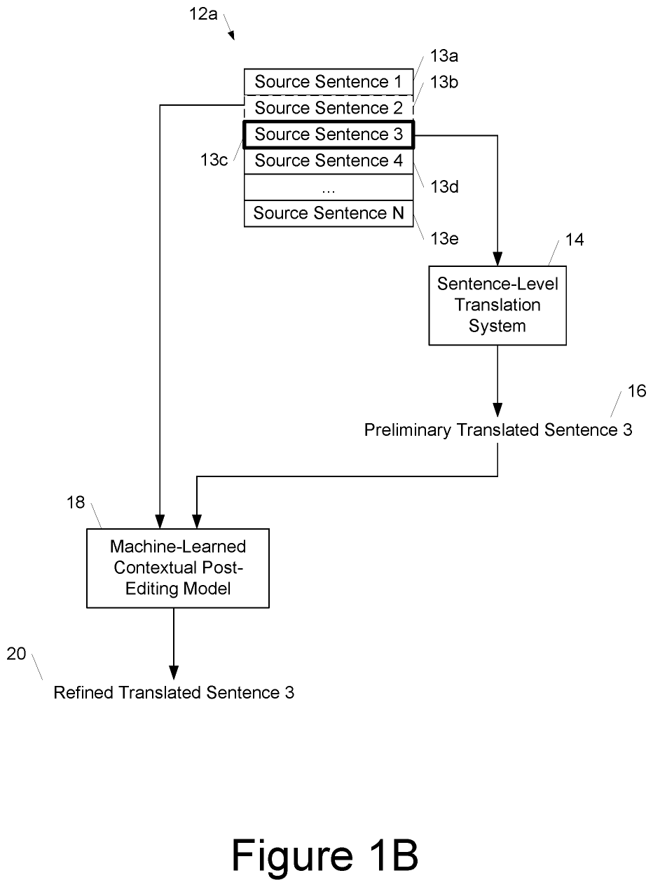

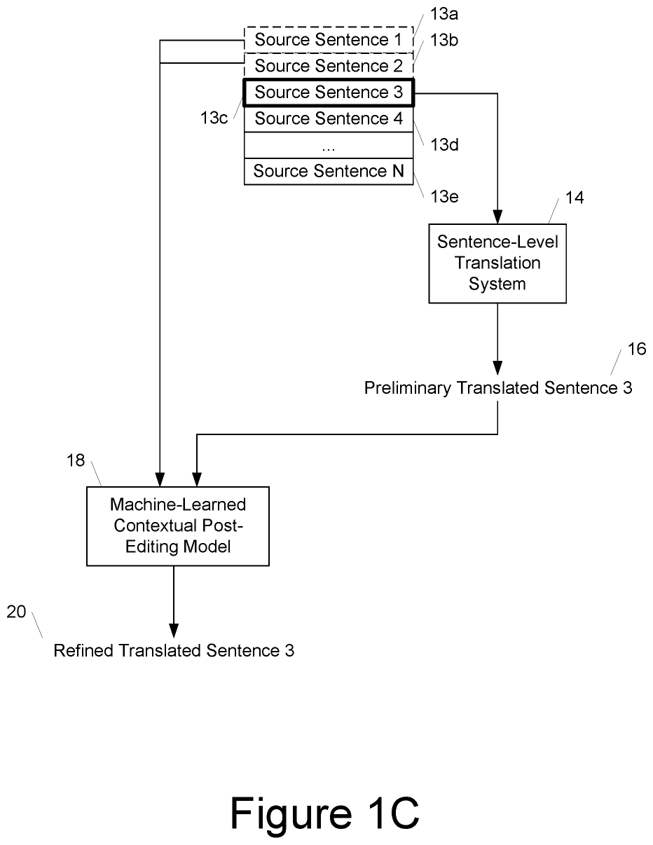

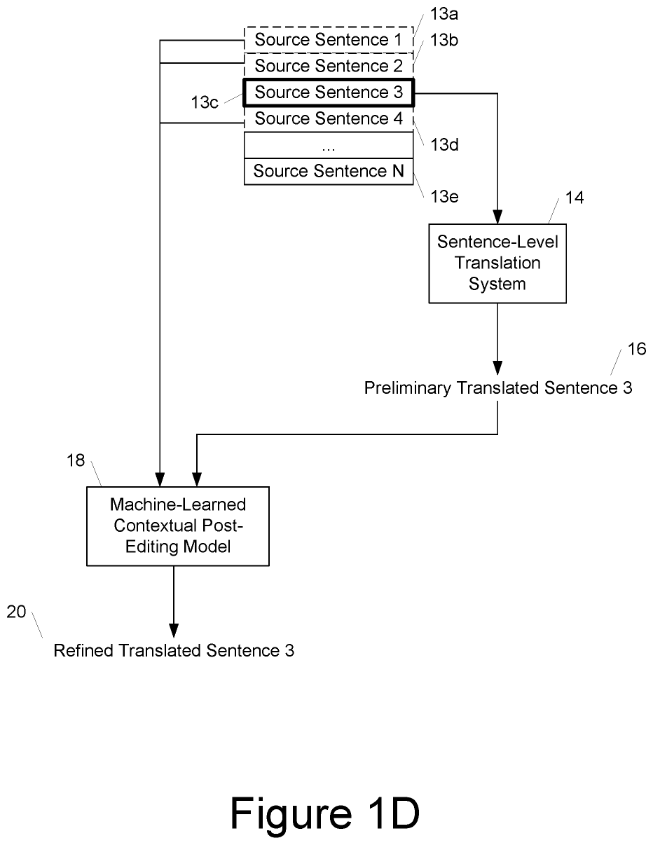

FIGS. 1A-D depict block diagrams of example systems to perform contextual post-editing of sentence-level translations according to example embodiments of the present disclosure. The example systems can leverage a machine-learned contextual post-editing model configured to refine a preliminary translation based on source context.

In particular, referring first to FIG. 1A, a computing system can obtain language data descriptive of a language source 12a that includes a plurality of source sentences in a first natural language (that is, a language spoken by humans). For example, the language source 12a can be an audio file that corresponds to speech of the plurality of source sentences, textual data that includes text of the plurality of source sentences, or imagery that visually depicts the plurality of source sentences. In some examples the language source 12a can be a document (e.g., a web document such as a website, a word processing document, etc.). In another example, the language source 12a can be an audio file associated with a video (e.g., a video posted to a social media or video sharing platform, a movie or show on a streaming platform, etc.).

Example implementations of the proposed systems and methods can first use a sentence-level translation system 14 to translate the plurality of source sentences to respectively obtain a plurality of preliminary translated sentences 16 in a second, different natural language. For example, the sentence-level translation system 14 can be an existing system that is leveraged to generate the preliminary translated sentences 16. FIG. 1A shows this preliminary translation process for a single source sentence 12b, but the preliminary translation via the system 14 can optionally be performed in parallel for all source sentences contained in the language source 12a.

For each of the preliminary translated sentences 16, the computing system can process, using a machine-learned contextual post-editing model 18, the preliminary translated sentence and language data 12c for at least one of the plurality of source sentences that does not correspond to the preliminary translated sentence (also referred to herein as “contextual source sentences”) to generate a refined translated sentence 20 for the preliminary translated sentence 16. The refined translated sentence 20 can be in the second language. The refined translated sentence 20 can fix common errors exhibited by the sentence-level translation system 14.

As illustrated in FIG. 1A, the refined translated sentence 20 can be provided as an output. The refined translated sentence 20 can be an audio file that corresponds to speech of the refined translated sentence, textual data that corresponds to text of the refined translated sentence, or imagery that depicts the refined translated sentence. For example, the refined translated sentence 20 can be displayed or rendered, added to a document, overlaid upon the language source, or spoken (e.g., by an artificial intelligence-based personal assistant).

Although FIG. 1A shows this example process being performed for one source sentence 12b, the process can be performed sequentially or in parallel for all source sentences contained in the language source 12a. Preliminary translations can be performed/generated at the same time as the refinements or they can be generated beforehand at an earlier, different time.

Various implementations of the proposed system can have varying amounts of context on the source (e.g., past and/or future contextual source sentences) and/or varying amounts of context on the target (e.g., past and/or future preliminary translations). To provide a more specific example, referring now to FIG. 1B, a language source 12a is shown that has N source sentences (e.g., shown at 13a-e). In FIG. 1B, the source sentence 3 13c is being translated. The source sentence 3 13c is translated by the sentence-level translation system 14 to generate preliminary translated sentence 3 16.

The machine-learned contextual post-editing model 18 can receive and process the preliminary translated sentence 3 16 and one or more contextual source sentences from the language source 12a. Specifically, as shown in FIG. 1B, source sentence 2 13b— the source sentence that immediately precedes the source sentence 13c— is provided to the model 18. On the basis of preliminary translated sentence 3 16 and source sentence 2 13b, the model 18 generates the refined translated sentence 3 20.

Other amounts of context from the source (e.g., past and/or future contextual source sentences) and/or varying amounts of context on the target (e.g., past and/or future preliminary translations) can be provided as well. For example, referring to FIG. 1C, additional preceding source context (also referred to as “past” or “left” context) is provided to the model 18. Specifically, source sentence 1 13a is provided to the model 18 in addition to source sentence 2 13b.

In another example, referring to FIG. 1D, some “future” or “right” source context can be provided to the model 18. Specifically, source sentence 4 13d is provided to the model 18 in addition to source sentence 1 13a and source sentence 2 13b.

Although not specifically illustrated in any of FIGS. 1A-D, any of these examples can also include providing past and/or future translated sentences to the model 18. The past and/or future translated sentences can include preliminary translated sentences and/or refined translated sentences. As one example, referring to FIG. 1D, the model 18 can be supplied with a preliminary translated sentence 1, 2, and/or 4 and/or a refined translated sentence 1, 2, and/or 4, which are translations of source sentences 1, 2, and/or 4.

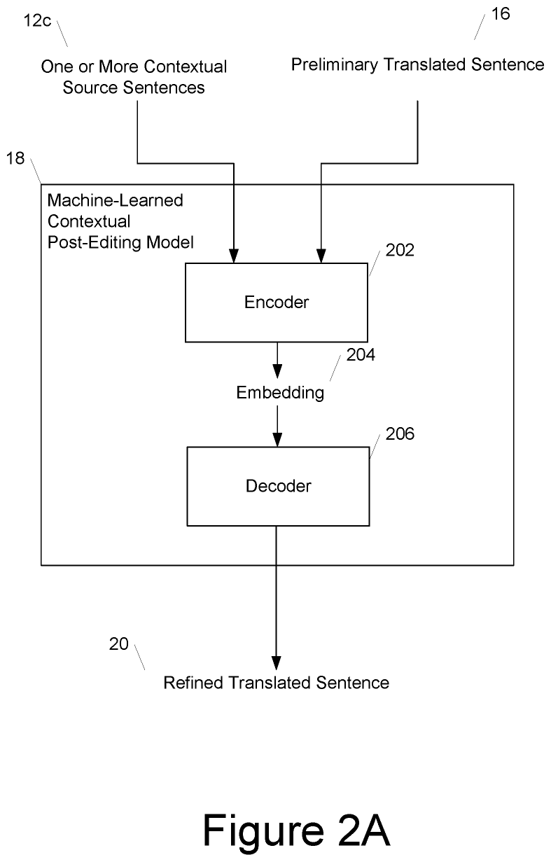

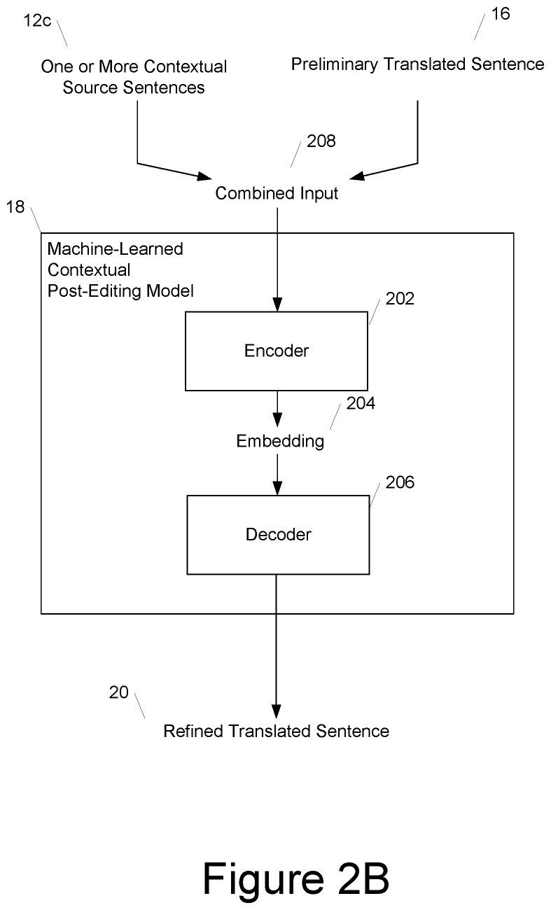

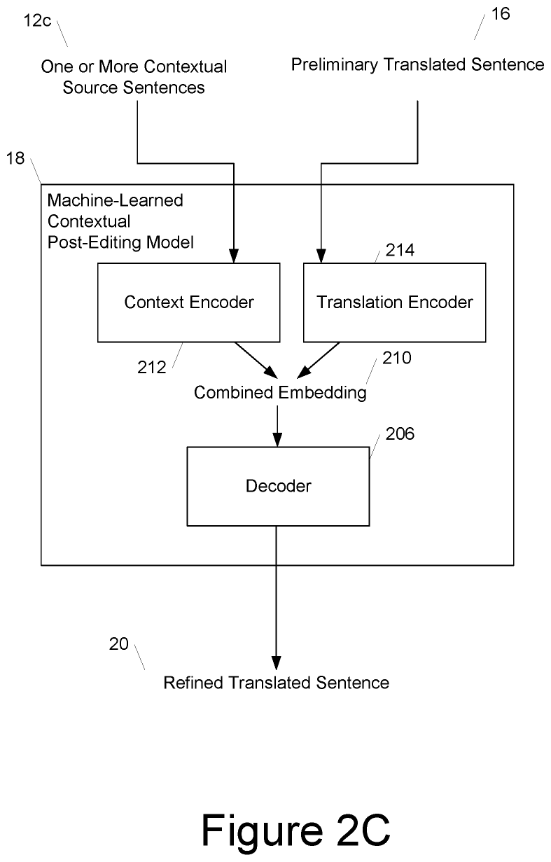

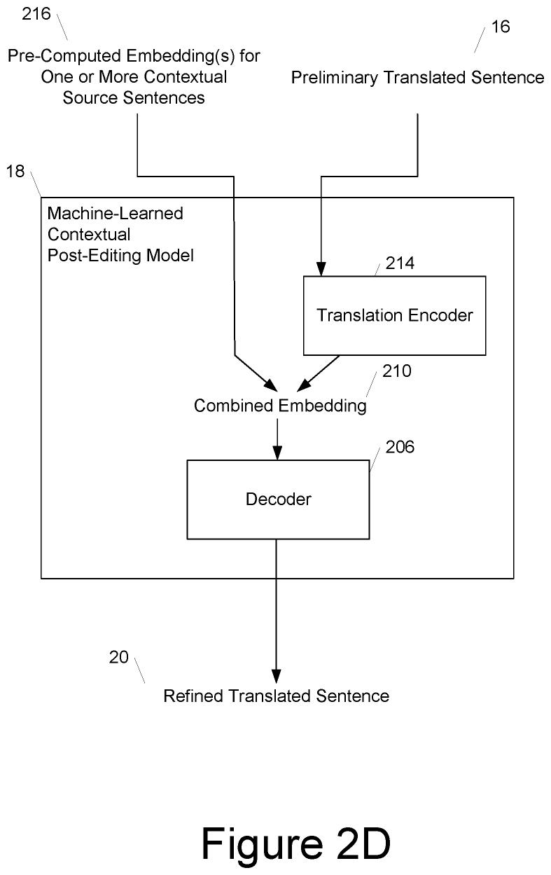

According to another aspect, in some implementations and as illustrated in FIG. 2A, the machine-learned contextual post-editing model 18 can include an encoder 202 and a decoder 206.

The encoder 202 can process the preliminary translated sentence 16 and the language data for at least one of the plurality of source sentences that does not correspond to the preliminary translated sentence (shown as contextual source sentences 12c) to generate an embedding 204 for the preliminary translated sentence 16.

The decoder 206 of the machine-learned contextual post-editing model 18 can process the embedding 204 for the preliminary translated sentence 16 to generate the refined translated sentence 20 for the preliminary translated sentence 16.

As examples, each of the encoder 202 and the decoder 206 can be or include transformer models, recurrent neural networks, and/or other models capable of processing or handling sequential data. As an example, the encoder 202 and the decoder 206 can be arranged as a sequence-to-sequence model (e.g., optionally featuring one or more attention mechanisms). For example, an attention mechanism can connect the encoder to the decoder or otherwise operate between the encoder and the decoder.

In some implementations, as shown in FIG. 2B, prior to input into the encoder 202, the preliminary translated sentence 16 and the contextual source sentences 12(c) can be combined to generate a combined input 208. For example, the combination can include concatenation, summation, averaging, maximum operations, and/or other mathematical operations, including complex combinations like an attention mechanism. The encoder 202 can process the combined input 208 to generate the embedding 204.

In some implementations, as shown in FIG. 2C, the encoder of the machine-learned contextual post-editing model 18 can be or include two different encoders: a context encoder 212 that encodes the one or more contextual source sentences 12c to generate a context embedding and a translation encoder 214 that encodes the preliminary translated sentence 16 to generate a translation embedding. The respective embeddings output by the encoders 212 and 214 can be combined to generate a combined embedding 210. The combining can include concatenation, summation, averaging, maximum operations, and/or other mathematical operations, including complex combinations like an attention mechanism.

In some implementations, as shown in FIG. 2D, the context embedding(s) for the contextual source sentence(s) can be pre-computed, stored, and then later accessed during refinement of the preliminary translation. For example, in FIG. 2D, pre-computed embeddings for the contextual source sentence(s) are shown at 216.

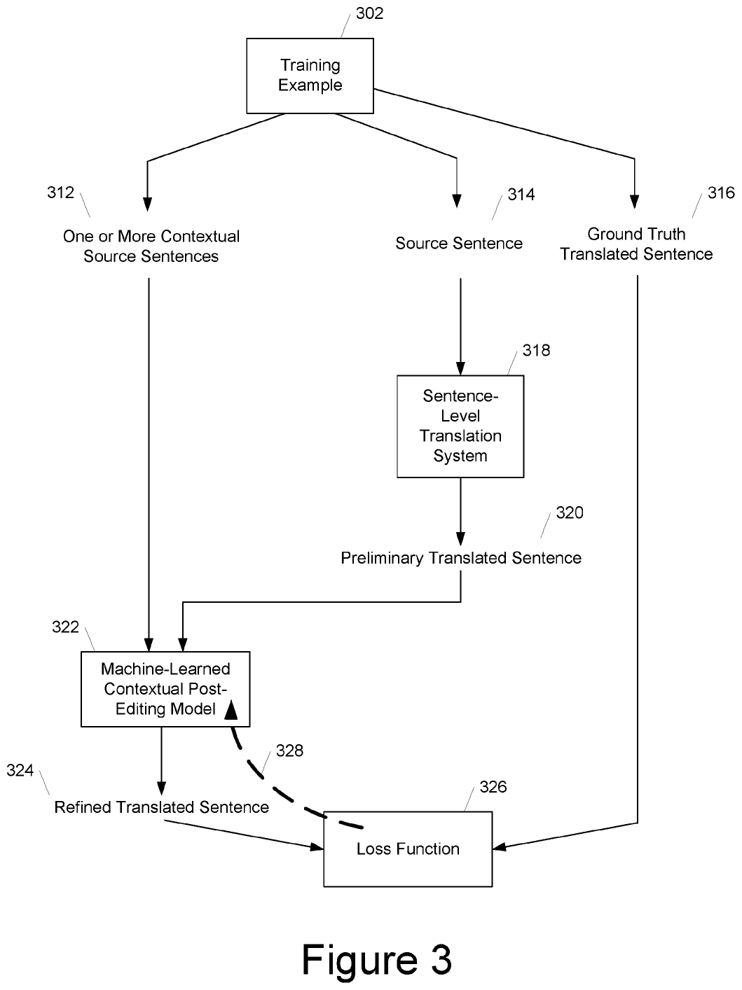

FIG. 3 depicts a block diagram of an example training scheme to train a machine-learned contextual post-editing model 322 according to example embodiments of the present disclosure. As illustrated in FIG. 3, the training process can be based on a training example 302. Although one training example 302 is shown, many training examples can be used iteratively and/or in parallel (e.g., as a batch or minibatch). The training examples may be multiple source sentences from corresponding ones of multiple language sources (source sequences).

The training example 302 can include language data that describes a plurality of source sentences in a first language and at least one ground truth translated sentence 316 that corresponds to a ground truth translation into a second, different language of at least one source sentence 314 of the plurality of source sentences in the training example 302. Although one source sentence 314 is shown in FIG. 3, the illustrated training process can be performed for each source sentence in the training example 302 for which a ground truth counterpart is available.

Referring still to FIG. 3, a sentence-level translation system 318 can translate the source sentence 314 to generate a preliminary translated sentence 320 in the second, different language.

The machine-learned contextual post-editing model 322 can process the preliminary translated sentence 320 and at least one of a plurality of source sentences 312 that does not correspond to the preliminary translated sentence 320 to generate a refined translated sentence 324 for the preliminary translated sentence 320. For example, if the source sentence 314 is a sentence from a given language source (e.g. a sentence from a passage of text), the at least one source sentence 312 may be at least one other sentence from the same language source. Thus, if, as noted above, the training employs (e.g. successively) multiple source sentences 314 drawn from more than one corresponding language sources, the contextual source sentence(s) for each source sentence 314 comprises one or more other sentences from the same language source. The model 322 can be the same as or similar to the models illustrated in FIGS. 1A-D and 2A-D. For example, past and/or future contextual translated data may be provided to the model 322 as well.

The training computing system can evaluate a loss function 326 which compares the refined translated sentence 324 with the ground truth translated sentence 316 that corresponds to the source sentence 314. For example, the loss function can be a cross-entropy loss function. As illustrated at 328, the training computing system can modify one or more values of one or more parameters of the machine-learned contextual post-editing model 322 based at least in part on the loss function 326. For example, the loss function 326 can be backpropagated through the model 322. Note that in contrast to many machine learning problems, typically multiple correct translations of the language source into the second language exist (e.g. translations which differ from each other only in that a given word of the first language is translated as two respective synonyms in the second language). In other words, the ground truth translated sentence 316 is a sentence from one of many possible correct translations of the corresponding language source. Thus, a discrepancy between the preliminary translated sentence 320 and the ground truth translated sentence 316 does not always mean that the preliminary translated sentence 320 is incorrectly translated. Nevertheless, surprisingly, it has been found that in implementations of the system of FIG. 3, convergence of the machine-learned contextual post-editing model 322 is achieved.

In some implementations, the post-editing model 322 can be trained to have control over the frequency of post-edits. For example, the system can be trained to always post-edit or post-edit only when context is relevant. The latter can be achieved by setting the initial and refined translation to the same value e.g. based on an estimate generated by a contextual importance estimation unit (not shown) that the context is not relevant. This teaches the model to produce identity. The contextual importance estimation unit may, for example, generate a contextual importance estimate by measuring the similarity of vocabulary for multiple source sentences (or preliminary translated sentences) of a given language source, and refines the preliminary translated sentences for that language source based on that contextual importance estimate. The proportion of identity examples (that is, sentences for which the initial and refined translations are set to be the same) can be controlled during training, e.g. as a hyper-parameter of the training algorithm. Experimentally, it has been found that arranging for −10% of the preliminary translated sentences to be identity examples provides good results.

In some cases, the preliminary and refined translations may be significantly similar to each other. To increase the efficacy of the training data, the loss on tokens that are unique to the refined translation (e.g., different from the preliminary translations) can be upweighted. Another approach can include upweighting certain types of language like pronouns.

### Example Devices and Systems

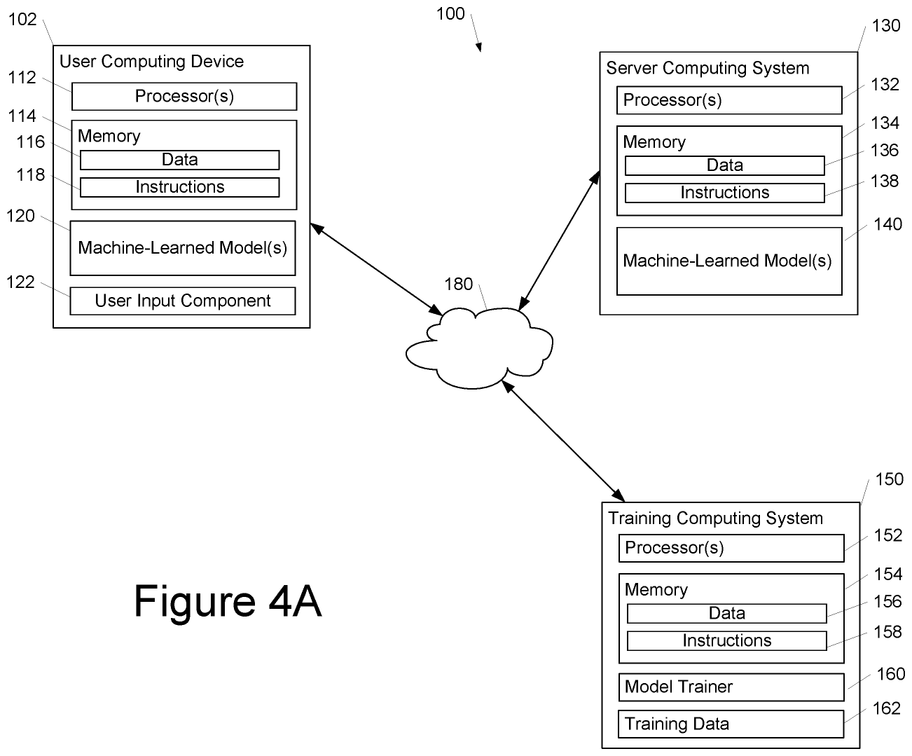

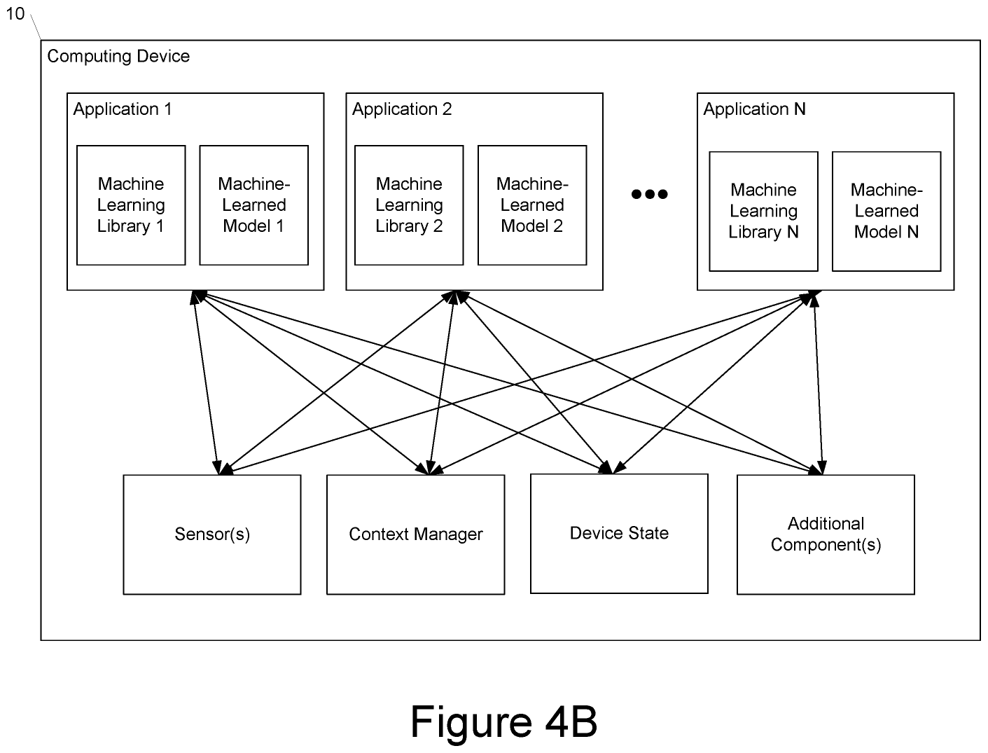

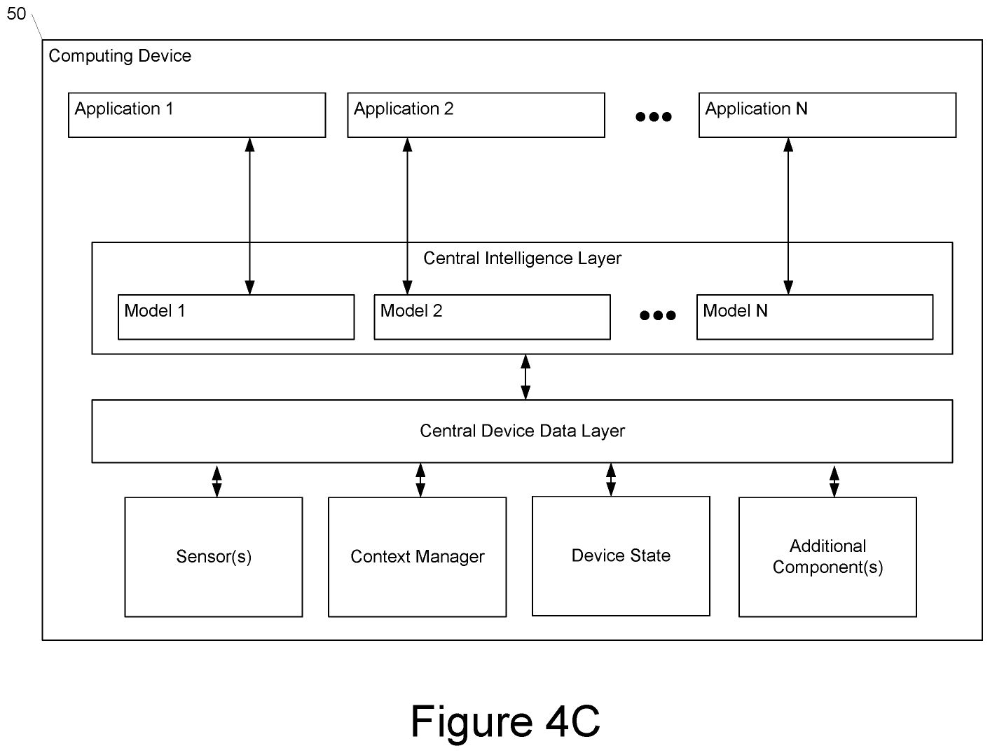

FIG. 4A depicts a block diagram of an example computing system 100 that performs machine translation according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, a FPGA, a controller, a microcontroller, etc.) and can be one processor or a plurality of processors that are operatively connected. The memory 114 can include one or more non-transitory computer-readable storage mediums, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

In some implementations, the user computing device 102 can store or include one or more machine-learned models 120. For example, the machine-learned models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Example machine-learned models 120 are discussed with reference to FIGS. 1A-3.

In some implementations, the one or more machine-learned models 120 can be received from the server computing system 130 over network 180, stored in the user computing device memory 114, and then used or otherwise implemented by the one or more processors 112. In some implementations, the user computing device 102 can implement multiple parallel instances of a single machine-learned model 120 (e.g., to perform parallel translation across multiple instances of language sources).

Additionally or alternatively, one or more machine-learned models 140 can be included in or otherwise stored and implemented by the server computing system 130 that communicates with the user computing device 102 according to a client-server relationship. For example, the machine-learned models 140 can be implemented by the server computing system 140 as a portion of a web service (e.g., a translation service). Thus, one or more models 120 can be stored and implemented at the user computing device 102 and/or one or more models 140 can be stored and implemented at the server computing system 130.

The user computing device 102 can also include one or more user input component 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, a FPGA, a controller, a microcontroller, etc.) and can be one processor or a plurality of processors that are operatively connected. The memory 134 can include one or more non-transitory computer-readable storage mediums, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Example models 140 are discussed with reference to FIGS. 1A-3.

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, a FPGA, a controller, a microcontroller, etc.) and can be one processor or a plurality of processors that are operatively connected. The memory 154 can include one or more non-transitory computer-readable storage mediums, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the machine-learned models 120 and/or 140 based on a set of training data 162. The training data 162 can include, for example, one or more training example pairs, where each training example pair includes language data that describes a plurality of source sentences in a first language and a plurality of ground truth translated sentences respectively corresponding to ground truth translations of the plurality of source sentences into a second, different language. For example, trusted experts can generate the training translations or existing high-quality translations (e.g., literary translations) can be used.

In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM hard disk or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

FIG. 4A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 4B depicts a block diagram of an example computing device 10 according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 4B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 4C depicts a block diagram of an example computing device 50 according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 4C, a respective machine-learned model (e.g., a model) can be provided for each application and managed by the central intelligence layer. In other implementations, two or more applications can share a single machine-learned model. For example, in some implementations, the central intelligence layer can provide a single model (e.g., a single model) for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 4C, the central device data layer can communicate with a number of other components of the computing device, such as, for example, one or more sensors, a context manager, a device state component, and/or additional components. In some implementations, the central device data layer can communicate with each device component using an API (e.g., a private API).

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

Although aspects of the present disclosure are described with reference to translation, they may also be applied to perform other language modification or editing tasks, including, e.g., grammatical correction. As one example, a computing system can include a machine-learned contextual post-editing model configured to refine a preliminary grammatical correction based on source context. The computing system can include instructions that, when executed by computing system, cause the computing system to perform operations, the operations comprising: obtaining language data that describes a plurality of source sentences; grammatically correcting each of the plurality of source sentences to obtain a plurality of preliminary corrected sentences; and, for each of the preliminary corrected sentences: processing, using the machine-learned contextual post-editing model, the preliminary correct sentence and the language data for at least one of the plurality of source sentences that does not correspond to the preliminary corrected sentence to generate a refined corrected sentence for the preliminary corrected sentence; and providing the refined corrected sentence as an output.

1. A computing system for performing contextual post-editing of sentence-level translations, the computing system comprising:
one or more processors; and
one or more non-transitory computer-readable media that collectively store:
a machine-learned contextual post-editing model configured to refine a preliminary translation based on source context; and
instructions that, when executed by the one or more processors, cause the computing system to perform operations, the operations comprising:
obtaining language data that describes a plurality of source sentences in a first natural language included in a language source;
translating each of the plurality of source sentences to obtain a plurality of preliminary translated sentences in a second, different natural language; and
for each of the preliminary translated sentences:
processing, using the machine-learned contextual post-editing model, the preliminary translated sentence and the language data for at least one of the plurality of source sentences that does not correspond to the preliminary translated sentence to generate a refined translated sentence for the preliminary translated sentence; and
providing the refined translated sentence as an output.

2. The computing system of claim 1, wherein:
the machine-learned contextual post-editing model comprises an encoder and a decoder; and
processing, using the machine-learned contextual post-editing model, the preliminary translated sentence and the language data for at least one of the plurality of source sentences that does not correspond to the preliminary translated sentence to generate the refined translated sentence comprises:
processing, using the encoder of the machine-learned contextual post-editing model, the preliminary translated sentence and the language data for at least one of the plurality of source sentences that does not correspond to the preliminary translated sentence to generate an embedding for the preliminary translated sentence; and
processing, using the decoder of the machine-learned contextual post-editing model, the embedding for the preliminary translated sentence to generate the refined translated sentence for the preliminary translated sentence.

3. The computing system of claim 2, wherein the encoder of the machine-learned contextual post-editing model comprises two different encoders that separately encode the preliminary translated sentence and the language data for at least one of the plurality of source sentences that does not correspond to the preliminary translated sentence.

4. The computing system of claim 2, wherein processing, using the encoder of the machine-learned contextual post-editing model, the preliminary translated sentence and the language data for at least one of the plurality of source sentences that does not correspond to the preliminary translated sentence to generate an embedding for the preliminary translated sentence comprises:
processing, using the encoder of the machine-learned contextual post-editing model, the preliminary translated sentence to generate a first portion of the embedding for the preliminary translated sentence; and
accessing a second portion of the embedding that corresponds to the at least one of the plurality of source sentences that does not correspond to the preliminary translated sentence and which was previously computed by the encoder of the machine-learned contextual post-editing model.

5. The computing system of claim 2, wherein processing, using the encoder of the machine-learned contextual post-editing model, the preliminary translated sentence and the language data for at least one of the plurality of source sentences that does not correspond to the preliminary translated sentence to generate an embedding for the preliminary translated sentence comprises:
combining the preliminary translated sentence and the language data for at least one of the plurality of source sentences that does not correspond to the preliminary translated sentence to generate a combined input; and
processing, using the encoder of the machine-learned contextual post-editing model, the combined input to generate an embedding.

6. The computing system of claim 1, wherein the at least one of the plurality of source sentences that does not correspond to the preliminary translated sentence consists of one or more source sentences that precede the source sentence that corresponds to the preliminary translated sentence in the language source.

7. The computing system of claim 1, wherein the at least one of the plurality of source sentences that does not correspond to the preliminary translated sentence comprise both:
one or more source sentences that precede the source sentence that corresponds to the preliminary translated sentence in the language source; and
one or more source sentences that are subsequent to the source sentence that corresponds to the preliminary translated sentence in the language source.

8. The computing system of claim 1, wherein:
the language data that describes the plurality of source sentences included in the language source comprises input audio data corresponding to speech of the plurality of source sentences; and
providing the refined translated sentence as the output comprises providing output audio data corresponding to speech of the refined translated sentence.

9. The computing system of claim 1, wherein:
the language data that describes the plurality of source sentences included in the language source comprises input textual data corresponding to text of the plurality of source sentences; and
providing the refined translated sentence as the output comprises providing output audio data corresponding to speech of the refined translated sentence.

10. A computer-implemented method for training a machine-learned contextual post-editing model to refine a preliminary translation based on source context, the method comprising:
obtaining, by a computing system comprising one or more computing devices, a training dataset comprising one or more training example pairs, each training example pair comprising language data that describes a plurality of source sentences in a first natural language and at least one ground truth translated sentence that corresponds to a ground truth translation into a second, different natural language of at least one source sentence of the plurality of source sentences; and
for the at least one source sentence of the plurality of source sentences:
using, by the computing system, a sentence-level translation system to translate the source sentence to generate a preliminary translated sentence in the second, different language;
processing, by the computing system and using the machine-learned contextual post-editing model, the preliminary translated sentence and at least one of the plurality of source sentences that does not correspond to the preliminary translated sentence to generate a refined translated sentence for the preliminary translated sentence;
evaluating, by the computing system, a loss function that compares the refined translated sentence with the ground truth translated sentence that corresponds to the source sentence; and
modifying, by the computing system, one or more values of one or more parameters of the machine-learned contextual post-editing model based at least in part on the loss function.

11. The computer-implemented method of claim 10, wherein:
the machine-learned contextual post-editing model comprises an encoder and a decoder; and
processing, using the machine-learned contextual post-editing model, the preliminary translated sentence and at least one of the plurality of source sentences that does not correspond to the preliminary translated sentence to generate the refined translated sentence comprises:
processing, using the encoder of the machine-learned contextual post-editing model, the preliminary translated sentence and the language data for at least one of the plurality of source sentences that does not correspond to the preliminary translated sentence to generate an embedding for the preliminary translated sentence; and
processing, using the decoder of the machine-learned contextual post-editing model, the embedding for the preliminary translated sentence to generate the refined translated sentence for the preliminary translated sentence.

12. The computer-implemented method of claim 11, wherein the encoder of the machine-learned contextual post-editing model comprises two different encoders that separately encode the preliminary translated sentence and the at least one of the plurality of source sentences that does not correspond to the preliminary translated sentence.

13. The computer-implemented method of claim 11, wherein processing, using the encoder of the machine-learned contextual post-editing model, the preliminary translated sentence and the at least one of the plurality of source sentences that does not correspond to the preliminary translated sentence to generate the embedding for the preliminary translated sentence comprises:
processing, using the encoder of the machine-learned contextual post-editing model, the preliminary translated sentence to generate a first portion of the embedding for the preliminary translated sentence; and
accessing a second portion of the embedding that corresponds to the at least one of the plurality of source sentences that does not correspond to the preliminary translated sentence and which was previously computed by the encoder of the machine-learned contextual post-editing model.

14. The computer-implemented method of claim 11, wherein processing, using the encoder of the machine-learned contextual post-editing model, the preliminary translated sentence and the language data for at least one of the plurality of source sentences that does not correspond to the preliminary translated sentence to generate an embedding for the preliminary translated sentence comprises:
combining the preliminary translated sentence and the language data for at least one of the plurality of source sentences that does not correspond to the preliminary translated sentence to generate a combined input; and
processing, using the encoder of the machine-learned contextual post-editing model, the combined input to generate an embedding.

15. The computer-implemented method of claim 10, wherein the at least one of the plurality of source sentences that does not correspond to the preliminary translated sentence consists of one or more source sentences that precede the source sentence in the training example pair.

16. The computer-implemented method of claim 10, wherein the at least one of the plurality of source sentences that does not correspond to the preliminary translated sentence comprise both:
one or more source sentences that precede the source sentence that corresponds to the preliminary translated sentence in the training example pair; and
one or more source sentences that are subsequent to the source sentence that corresponds to the preliminary translated sentence in the training example pair.

17. The computer-implemented method of claim 10, wherein:
the language data that describes the plurality of source sentences included in the training example pair comprises input audio data corresponding to speech of the plurality of source sentences; and
the refined translated sentence comprises output audio data corresponding to speech of the refined translated sentence.

18. The computer-implemented method of claim 10, wherein:
the language data that describes the plurality of source sentences included in the training example pair comprises input textual data corresponding to text of the plurality of source sentences; and
the refined translated sentence comprises output text data corresponding to text of the refined translated sentence.

19. One or more non-transitory computer-readable media that collectively store program instructions which when implemented by one or more processors implement a machine-learned contextual post-editing model by performing operations, the operations comprising:
obtaining language data that describes a plurality of source sentences in a first natural language included in a language source;
translating each of the plurality of source sentences to obtain a plurality of preliminary translated sentences in a second, different natural language; and
for each of the preliminary translated sentences:
processing, using the machine-learned contextual post-editing model, the preliminary translated sentence and the language data for at least one of the plurality of source sentences that does not correspond to the preliminary translated sentence to generate a refined translated sentence for the preliminary translated sentence; and
providing the refined translated sentence as an output.
